(19) United States
(12) Patent Application Publication
(10) Pub. No.: US 2022/0357360 A1
(43) Pub. Date: Nov. 10, 2022

(54) SEMICONDUCTOR-LASER-INTEGRATED ATOMIC FORCE MICROSCOPY OPTICAL PROBE

(71) Applicants: ALEXANDER A. UKHANOV, ALBUQUERQUE, NM (US); GENNADY A. SMOLYAKOV, ALBUQUERQUE, NM (US); FEI HUNG CHU, FREMONT, CA (US)

(72) Inventors: ALEXANDER A. UKHANOV, ALBUQUERQUE, NM (US); GENNADY A. SMOLYAKOV, ALBUQUERQUE, NM (US); FEI HUNG CHU, FREMONT, CA (US)

(73) Assignee: ACTOPROBE LLC, ALBUQUERQUE, NM (US)

(21) Appl. No.: 17/697,314

(22) Filed: Mar. 17, 2022

Related U.S. Application Data
(60) Provisional application No. 63/183,958, filed on May 4, 2021.

(51) Int. Cl. G01Q 60/38; G01Q 60/32; G01Q 80/00; G01Q 70/12

(52) U.S. Cl. CPC G01Q 60/38; G01Q 60/32; G01Q 80/00; G01Q 70/12

(57) ABSTRACT

A new semiconductor-laser-integrated Atomic Force Microscopy (AFM) optical probe integrates a semiconductor laser and a silicon cantilever AFM probe into a robust easy-to-use chip to enable AFM measurements, optical imaging, and spectroscopy at the nanoscale.

### CROSS REFERENCE TO RELATED APPLICATIONS

This application claims benefit and priority of U.S. provisional application Ser. No. 63/183958 filed May 4, 2021, the entire disclosure of which is incorporated herein by reference.

### FIELD OF THE INVENTION

The present invention relates to AFM microscopy and near-field optical microscopy probes and, in particular, to a semiconductor-laser-integrated AFM optical probe capable of performing both conventional AFM measurements and near-field optical imaging and spectroscopy at the nanoscale.

### BACKGROUND OF THE INVENTION

While science and technology greatly benefit from AFM in surface characterization, optical imaging at the nanoscale, such as NSOM and TERS, lags far behind. Current AFM technology obtains information about the mechanical properties only. Hybrid AFM equipped with a specialized far-field optical microscope or NSOM are normally used to probe the optical properties of the sample. These techniques have limited applications since they are expensive and difficult to use.

### A. Semiconductor-Laser-Integrated AFM Optical Probes

We propose a novel class of laser-integrated optical probes for combined AFM/NSOM/TERS and Tip-Enhanced FTIR measurements. AFM optical probes (AOPs) are near-field optical probes that fit onto a conventional AFM and allow one to combine the high lateral resolution of AFM with near-field optical measurements. AOPs are considered to be a cost-effective alternative to expensive NSOMs and to various hybrids of AFMs equipped with specialized far-field optical microscopes.

### B. Ultrafast Pulsed AOP Technology

In addition to unique imaging/spectroscopy capabilities, the semiconductor-laser-integrated AOP technology can be naturally extended to ultrafast pulsed (UFP) AOP technology that provides an exciting opportunity for obtaining both space- and time-resolved chemical information by way of ultrafast TERS measurements, and, most importantly, extends the AOP technology into the visible optical range by using nonlinear optical effects such as two-photon or three-photon excitation and detection. Integration of an external pulsed excitation source with TERS for time-resolved spectroscopy is very challenging [1]. In contrast, the UFP AOP technology naturally provides the ultrafast time-resolved spectroscopy capability. The integrated semiconductor laser sources with specialized gain media, such as InAs quantum dots, offer mode-locking capabilities for sub-picosecond pulse generation [2, 3]. Integrating the ultrafast pulsed laser source into a silicon cantilever AFM probe will allow probing the site-specific dynamic response of chemical systems. This imaging technique combining molecular scale spatial resolution and ultrafast temporal resolution can be applied, e.g., for exploring energy flow, molecular dynamics, breakage/formation of chemical bonds or conformational changes in nanoscale systems, and so on.

UFP AOP will also be of particular interest for tip-enhanced hyper-Raman spectroscopy (TEHRS) of biological samples. Hyper-Raman scattering (HRS) is a two-photon-excited Raman scattering process that provides several advantages over one-photon excitation [4-6]. In an HRS experiment, the excitation with light in the near infrared, convenient for biological samples, is combined with the desirable detection in the visible spectral range. Besides, the two-photon excitation is favorable for microscopic applications due to the increased penetration depth and limited probed volume [7], resulting in an improved resolution for imaging. Last but not least, TEHRS benefits even to a greater extent from the high local optical fields than normal Raman scattering does in the case of TERS, because of its nonlinear dependence on the enhanced excitation field. TEHRS, therefore, has the potential to be much more sensitive than TERS and to provide better insight into the structure and interaction of molecules on surfaces [8]. As a nonlinear incoherent Raman process, HRS is an extremely weak effect with scattering cross-sections 35 orders of magnitude smaller than cross-sections of “normal” (one-photon-excited) Raman scattering. To be observed, the effect requires very high excitation intensities provided in high-energy laser pulses [9] or by tightly focused femtosecond or picosecond mode-locked lasers [10]. In TEHRS, however, the strong field enhancement can compensate for the extremely small cross-section of HRS and allows the measurement of TEHRS spectra at excitation intensities of 10⁶ to 10⁷ W/cm² [11], conditions that can be easily achieved with mode-locked picosecond lasers under focusing conditions of UFP AOP.

### C. AOP Technology for Rapid Virus Detection/Identification and DNA/RNA Sequencing

Preliminary analysis shows that the AOP technology is extremely attractive for rapid virus detection/identification and DNA sequencing. Rapid diagnosis of virus infection is critical for controlling viral spread in its early stage. Developing simple, fast, and economical virus detection techniques is crucial for early viral infection identification, early treatment, and increased likelihood of patient survival. The mainstream methods in virus surveillance such as fluorescent antibody assays, enzyme-linked immunosorbent assay (ELISA), and polymerase chain reaction (PCR) are based on the detection of viral antigens and/or nucleic acids of viruses. Most of these technologies suffer from complex procedures, poor sensitivity, as well as time and cost ineffectiveness. Collected samples are subjected to a series of time-consuming steps, such as ultracentrifugation and cell culture, to enrich virus particles or amplify virus titers. The low virus titer in most samples leads to sequence reads dominated by host genetic material rather than by viral pathogens. Various enrichment methods, including virus culture and genome amplification, often introduce artificial variants in the sequence reads and are impractical when samples are time sensitive. In addition, the requirement for predefined labels such as target virus-specific antibodies limits use of the conventional methods for the rapid identification of newly emerging viruses.

Viruses possess surface proteins and lipids that can generate distinctive Raman signals, and Raman spectroscopy has been identified as a suitable and effective tool to examine a single live cell for virus infection without the need for labeling and the time it takes to do so [12-19]. The obvious advantage of the Raman technique over conventional immunostaining and genetic tests for detection of human infectious viruses is that it does not require any genetic or proteomic information about the virus in advance. Tip-enhanced Raman spectroscopy (TERS) [12, 14, 20], surface-enhanced Raman spectroscopy (SERS) [13, 15, 19, 21-27], and volume-enhanced Raman spectroscopy (VERS) [18] have been applied to virus detection and identification. However, purification of biological samples and massive virus culture amplification were still needed for reliable virus detection and identification. Raman techniques capable of single-particle detection and identification of viruses, whose typical size is sub-100 nm, are in high demand. A unique submolecular resolution of the AOP technology can be used for rapid and label-free optical detection and identification of viruses directly from clinical samples without their preliminary purification or enrichment.

DNA sequencing is a bottleneck of modern genomics and bioinformatics. Therefore, alternative methods of DNA and RNA sequencing are highly desired. During the last two decades, some attempts have been made to read DNA and RNA nucleotide sequences using TERS. Unfortunately, biological molecules such as DNA have much lower Raman scattering cross sections than the resonant dyes commonly investigated in single-molecule TERS, making their detection challenging. The temptation to simply raise the excitation laser power to generate more Raman scattering leads to decomposition. If one works at sufficiently low laser power, long integration times are required, which leads to slow imaging rates and problems with drift. There have been claims of nanometer or even subnanometer spatial resolution with ambient TERS. The Deckert group attempted to reach <1 nm spatial resolution using TERS for sequencing specifically designed single-stranded DNA [28]. However, such high-resolution TERS proved extremely difficult to reproduce. At present, there is only one other report in the literature where a silver tip was scanned along a single-stranded DNA to collect TERS signals with a step of 0.5 nm, comparable to the bond length between two adjacent DNA bases [29]. A unique single-molecule sensitivity and spatial resolution of the AOP technology can be used for rapid sequencing single- and double-stranded DNA and RNA.

### SUMMARY OF THE INVENTION

The innovation is accomplished by integrating a semiconductor laser source and a photodetector into a cantilevered silicon AFM probe. Because the production of individual probes is tedious and not easily reproducible, it is desirable to fabricate standardized probes in large batches with highly reproducible properties (e.g., aperture size, shape, and, hence, transmission) using established silicon microfabrication techniques of the standard AFM cantilever technology. Delivery of light to the optical probe tip is an obvious problem in such a concept due to the absence of Si-based laser sources, and, as a consequence, most developments deal with the microfabrication of aperture tips only that can then be bonded to fibers or integrated into a cantilever. Fabrication of passive cantilevered probes has been attempted by integrating a waveguide into the cantilever. Silicon microstructures are in principle compatible with semiconductor laser functionality and fabrication of light-emitting cantilevered probes can be attempted by integrating a semiconductor laser source directly into the silicon cantilever or its base. We propose a special design for the AOP where a semiconductor laser chip is integrated into a commercial silicon cantilever AFM probe, and the free propagating light from the integrated laser source is used to illuminate the probe tip and carry out AFM, NSOM, and TERS measurements.

The advantages of the present invention will become more readily apparent from the following detailed description taken with the following drawings.

### BRIEF DESCRIPTION OF THE DRAWINGS

FIG. 1 is a three-dimensional illustration of the semiconductor-laser-integrated AOP concept according to Embodiment 1 of the invention.

FIG. 2 is an illustration of a three-section semiconductor laser device divided into an electrically isolated gain section and two parallel absorber sections on both sides of the gain section.

FIG. 3 is a three-dimensional illustration of the semiconductor-laser-integrated AOP concept according to Embodiment 1 of the invention.

FIG. 4 is a three-dimensional illustration of the semiconductor-laser-integrated AOP concept according to Embodiment 1 of the invention.

FIG. 5 is a three-dimensional illustration of the semiconductor-laser-integrated AOP concept according to Embodiment 2 of the invention.

FIG. 6 is a three-dimensional illustration of the semiconductor-laser-integrated AOP concept according to Embodiment 2 of the invention.

FIG. 7 is a three-dimensional illustration of the semiconductor-laser-integrated AOP concept according to Embodiment 2 of the invention.

FIG. 8 is a top view of a semiconductor laser chip bonded to a silicon probe.

FIG. 9 is a side view and SEM image of a semiconductor laser chip bonded to a silicon probe.

FIG. 10 is an illustration of optical spectrum of a silicon-integrated laser source, measured using the light scattered from the probe tip.

FIG. 11 is an illustration of the results of near-field optical testing of a silicon-integrated AFM optical probe.

FIG. 12 is an illustration of the results of experimental measurement of the laser beam divergence.

FIG. 13 is an illustration of a two-section semiconductor laser device divided into electrically isolated gain section and saturable absorber section to allow ultrafast pulse generation capability according to Embodiment 3 of the invention.

### DETAILED DESCRIPTION OF THE INVENTION

The semiconductor-laser-integrated AOP concept is based on integrating a semiconductor laser source into a cantilevered silicon AFM probe. Some preferred embodiments of the invention will be described below in detail based on the drawings.

### Embodiment 1

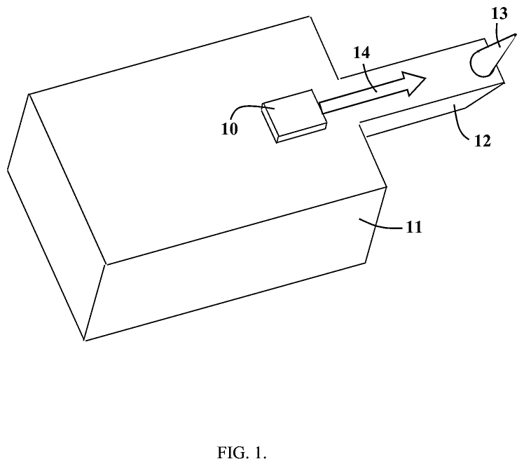

In an illustrative embodiment of the present invention (FIG. 1), a semiconductor laser chip 10 is bonded directly to the top surface of the base 11 of a commercial AFM probe in front of the cantilever 12 without any prior probe modification (no pit receptor site etching into the base of the probe). The active region of the laser chip is aligned with the probe tip 13, so that the free propagating light 14 from the integrated laser source can be used to illuminate the probe tip and carry out AFM, NSOM, and TERS measurements. To prevent strong divergence of the free propagating laser light, the silicon-integrated laser chip 10 can be fabricated from a specially designed semiconductor laser epitaxial structure with significantly improved divergence along the fast axis (across the epitaxial layers). This special design of the laser epitaxial structure is expected to radically improve delivery of the laser light to the probe tip. In particular, the longitudinal photonic band crystal (PBC) waveguide design can be used [30-34]. The longitudinal PBC design demonstrates a vertical divergence angle less than 10 degrees full width at half maximum (FWHM). An example of such design is given in [32].

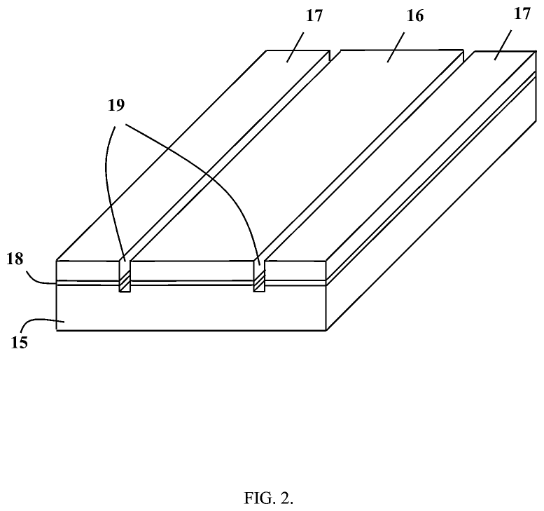

To allow light detection capability, the silicon-integrated semiconductor laser chip can be processed into a three-section device 15 divided into an electrically isolated gain section 16 and two parallel absorber sections 17 on both sides of the gain section (FIG. 2). Electrical isolation between the gain and absorber sections is achieved by using deep etching through the active layer 18 to remove any layers in the gap regions 19. The absorber sections can be used as an efficient integrated photodetector (PD). The voltages of proper polarity and magnitude are applied to the gain and PD sections to achieve laser generation in the gain section and light detection in the PD sections.

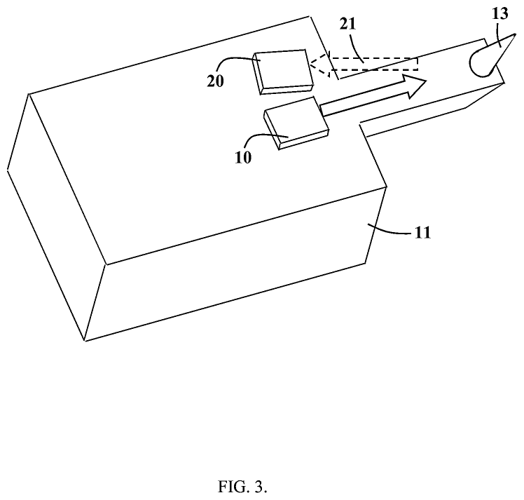

Alternatively, a second semiconductor laser chip 20 with the same epitaxial structure is bonded directly to the top surface of the base 11 of a commercial AFM probe alongside the first semiconductor laser chip 10 (FIG. 3). The active region of the second laser chip is aligned with the probe tip 13, so that the light 21 scattered from the probe tip is coupled back into the active region of the second laser chip. The voltage of proper polarity and magnitude is applied to the active region of the second semiconductor laser chip to achieve detection of the scattered light.

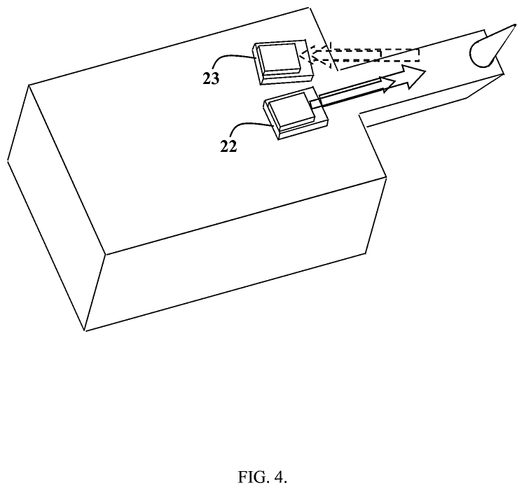

The first and second semiconductor laser chips, in their turn, can be fabricated as vertically integrated stacks (22, 23) of two or more semiconductor laser chips with different epitaxial structures corresponding to different emission wavelengths (FIG. 4). The first and second semiconductor laser chips of stacked geometry are supplied with the voltages of proper polarity and magnitude to achieve laser generation and light detection at multiple wavelengths, in the first and second semiconductor laser chips, respectively.

### Embodiment 2

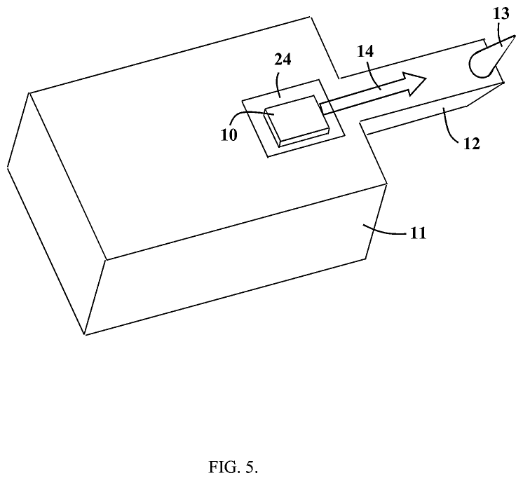

In another illustrative embodiment of the present invention (FIG. 5), a semiconductor laser chip 10 is buried in the base 11 of a commercially available silicon AFM probe in front of the cantilever 12. The active region of the laser chip is aligned with the probe tip 13 to efficiently deliver the free propagating laser light 14 to the probe tip. The semiconductor laser chip is metal-bonded within etched pit receptor site 24 inside the base of the silicon AFM probe in such a way that the active region of the laser chip is above the top surface of the base, and the emitted laser light can propagate freely in air to illuminate the probe tip and allow AFM, NSOM, and TERS measurements. To prevent strong divergence of the free propagating laser light and radically improve delivery of the laser light to the probe tip, the silicon-integrated laser chip 10 can be fabricated from a specially designed semiconductor laser epitaxial structure with significantly improved divergence along the fast axis (across the epitaxial layers). In particular, the PBC-waveguide design of the laser epitaxial structure can be used.

To allow light detection capability, the silicon-integrated semiconductor laser chip can be processed into a three-section device 15 divided into an electrically isolated gain section 16 and two parallel absorber sections 17 on both sides of the gain section (FIG. 2). Electrical isolation between the gain and absorber sections is achieved by using deep etching through the active layer 18 to remove any layers in the gap regions 19. The absorber sections can be used as an efficient integrated photodetector (PD). The voltages of proper polarity and magnitude are applied to the gain and PD sections to achieve laser generation in the gain section and light detection in the PD sections.

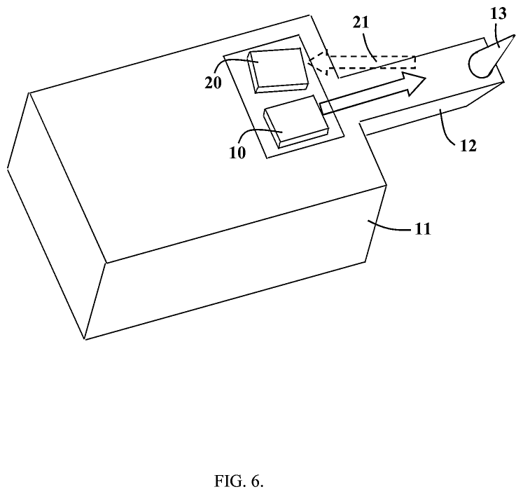

Alternatively, a second semiconductor laser chip 20 with the same epitaxial structure is buried in the base 11 of a commercially available silicon AFM probe in front of the cantilever 12 alongside the first semiconductor laser chip 10 (FIG. 6). The active region of the second laser chip is aligned with the probe tip 13, so that the light 21 scattered from the probe tip is coupled back into the active region of the second laser chip. The voltage of proper polarity and magnitude is applied to the active region of the second semiconductor laser chip to achieve detection of the scattered light.

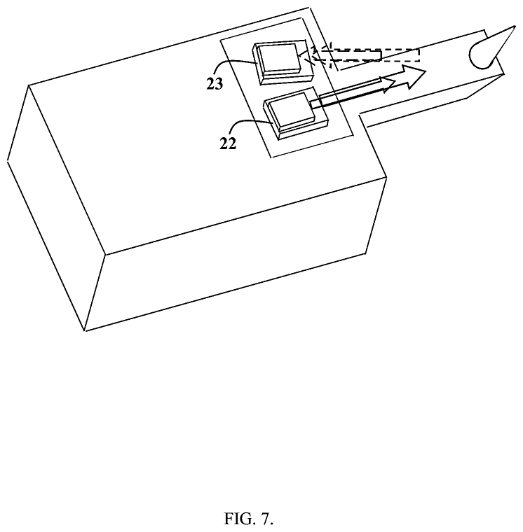

The first and second semiconductor laser chips, in their turn, can be fabricated as vertically integrated stacks (22, 23) of two or more semiconductor laser chips with different epitaxial structures corresponding to different emission wavelengths (FIG. 7). The first and second semiconductor laser chips of stacked geometry are supplied with the voltages of proper polarity and magnitude to achieve laser generation and light detection at multiple wavelengths, in the first and second semiconductor laser chips, respectively.

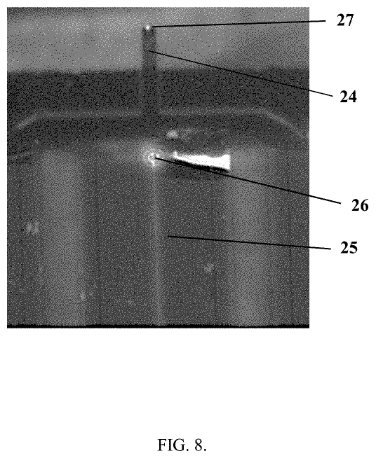

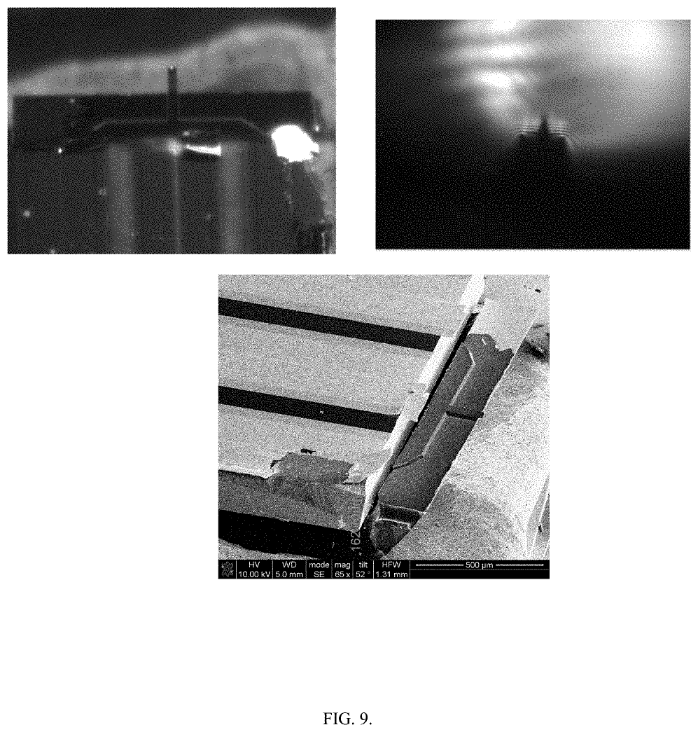

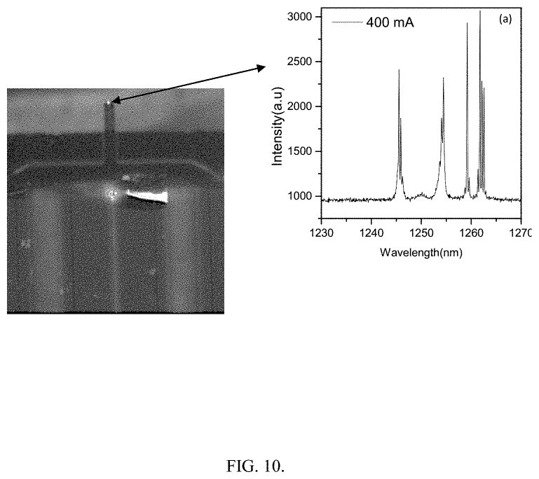

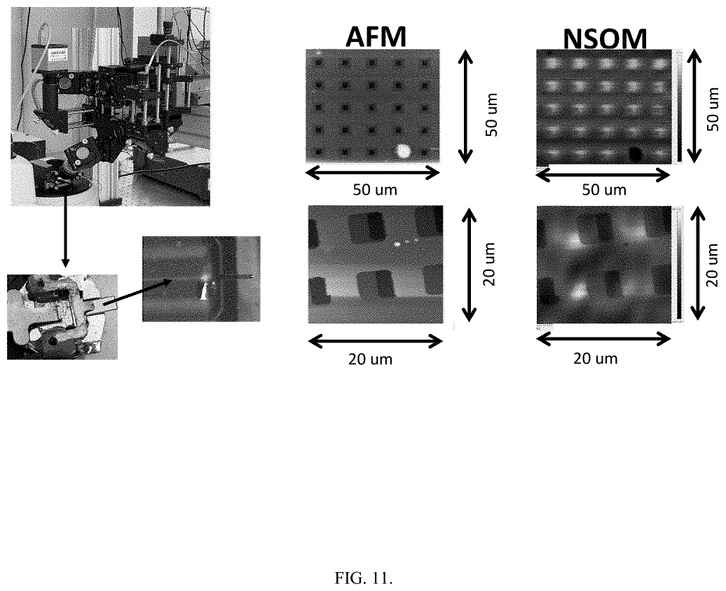

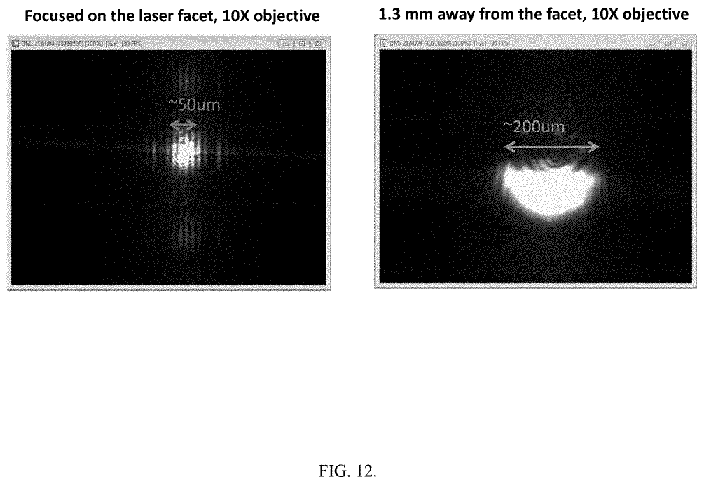

FIGS. 8 and 9 show an example of a silicon-integrated AFM optical probe [35]. Using lithography and ICP dry etching, a standard silicon AFM probe 24 was patterned and etched to a depth of 150 μm to accommodate a thick PBC-waveguide laser chip 25. FIG. 8 shows the laser chip bonded to the silicon probe with indium. The top view shows the laser light 26 at the output facet of the laser and scattered light 27 at the tip. FIG. 9 also shows the side view and SEM image of the silicon-integrated AFM optical probe. FIG. 10 shows the optical spectrum of the silicon-integrated laser source, measured using the light scattered from the probe tip. The results of near-field optical testing of the silicon-integrated AFM optical probe are presented in FIG. 11. FIG. 12 summarizes the results of an experimental measurement of the laser beam divergence. The transverse size of the laser beam is measured directly on the laser output facet and 1.3 mm away from the output facet.

### Embodiment 3

Combining AFM probe with ultrafast near-field light source allows one to simultaneously achieve single-molecule spatial resolution and subpicosecond time resolution. The best way to achieve ultrafast laser pulse generation is to employ a passive mode-locking technique by dividing the laser cavity into two sections—a longer gain section and a shorter saturable absorber section. The gain section is forward biased, while the saturable absorber section is reverse biased. Electrical isolation between these two sections is achieved by using shallow dry etching to remove the heavily doped layers in the gap region.

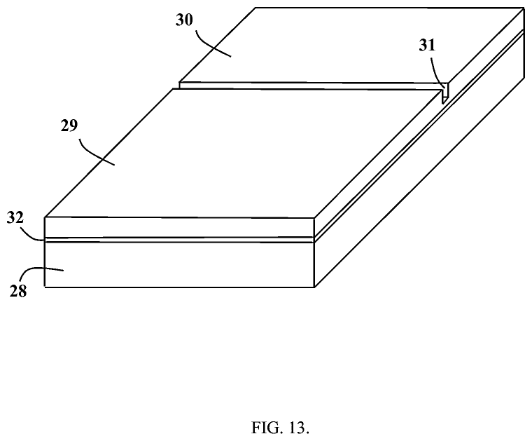

Another illustrative embodiment of the present invention is similar to Embodiment 1 and Embodiment 2, except that the semiconductor laser chip is a two-section device 28 divided into electrically isolated gain section 29 and saturable absorber section 30 to allow ultrafast pulse generation capability (FIG. 13). The epitaxial gain material piece is either metal-bonded directly to the top surface of the base of a commercial AFM probe or metal-bonded to the silicon substrate within a pre-etched pit receptor site inside the base of the probe and then processed into the two-section laser chip. Electrical isolation between the gain and absorber sections is achieved by using shallow dry etching to remove any heavily doped layers in the gap region 31 that does not penetrate the active region 32. The saturable absorber section can be used as an efficient intracavity high-speed photodetector (PD). The voltages of proper polarity and magnitude are applied to the gain and absorber/PD sections to achieve mode locking and intracavity light detection.

### Method Embodiment for Virus Detection Using AOP

A method embodiment of the invention provides a method of virus detection and identification using AOP. The method embodiment includes the steps of providing a semiconductor-laser-integrated atomic force microscopy optical probe comprising a semiconductor laser chip providing a gain medium section, a silicon cantilever atomic force microscopy probe, and a photodetector, all integrated into a single chip; mounting the semiconductor-laser-integrated atomic force microscopy optical probe on an atomic force microscopy system; applying a direct current bias to the semiconductor laser chip such that the laser light power delivered to the tip apex of the probe is sufficient to do tip-enhanced Raman scattering or near-field scanning optical microscopy measurements; applying reverse voltage bias to the photodetector; and performing a tip-enhanced Raman scattering measurement or near-field scanning optical microscopy measurement on a single virus particle.

### Method Embodiment for DNA/RNA Sequencing Using AOP

A method embodiment of the invention provides a method of DNA/RNA sequencing using AOP. The method embodiment includes the steps of providing a semiconductor-laser-integrated atomic force microscopy optical probe comprising a semiconductor laser chip providing a gain medium section, a silicon cantilever atomic force microscopy probe, and a photodetector, all integrated into a single chip; mounting the semiconductor-laser-integrated atomic force microscopy optical probe on an atomic force microscopy system; applying a direct current bias to the semiconductor laser chip such that the laser light power delivered to the tip apex of the probe is sufficient to do tip-enhanced Raman scattering or near-field scanning optical microscopy measurements; applying reverse voltage bias to the photodetector; and performing a tip-enhanced Raman scattering measurement or near-field scanning optical microscopy measurement on a single-stranded DNA, double-stranded DNA, or RNA molecules, stretched and attached to a fixed surface at both ends, by way of base-to-base readout necessary for DNA/RNA sequencing.

In all embodiments, the semiconductor laser chip can be based on one of the following semiconductor materials: GaAs, InP, GaP, GaSb, and GaN.

In all embodiments, the optical gain in the silicon-integrated laser chip can be provided by bulk active region, by single or multiple quantum well active layers, or by a single or multiple layers of quantum dots in the active region of the epitaxial structure. The epitaxial structure of the laser chip can be that of quantum cascade semiconductor laser.

In all embodiments, the silicon cantilever atomic force microscopy probe used for integration with the semiconductor laser chip can alternatively be a silicon nitride cantilever atomic force microscopy probe.

### REFERENCES CITED

[1] J. M. Klingsporn, M. D. Sonntag, T. Seideman, R. P. Van Duyne, “Tip-enhanced Raman spectroscopy with picosecond pulses”, J. Phys. Chem. Lett. 5 (#1), pp. 106-110, 2014.
[2] X. Huang, A. Stintz, H. Li, L. F. Lester, J. Cheng, and K. J. Malloy, “Passive mode-locking in 1.3 μm two-section InAs quantum dot lasers,” Appl. Phys. Lett. 78(#19), pp. 2825-2827, 2001.
[3] E. U. Rafailov, M. A. Cataluna, W. Sibbett, “Mode-locked quantum-dot lasers”, Nature Photonics 1, pp. 395-401, 2007.
[4] J. Kneipp, H. Kneipp, K. Kneipp, “Two-photon vibrational spectroscopy for biosciences based on surface-enhanced hyper-Raman scattering”, Proc. Natl. Acad. Sci. USA 103(#46), pp. 17149-17153, 2006.
[5] F. Madzharova, Z. Heiner, J. Kneipp, “Surface enhanced hyper Raman scattering (SEHRS) and its applications”, Chem. Soc. Rev. 46(#13), pp. 3980-3999, 2017.
[6] C. Dab, C. Awada, A. Ruediger, “Tip-enhanced second harmonic generation: an approach for hyper-Raman spectroscopy”, Plasmonics 14(#3), pp. 653-661, 2019.
[7] W. R. Zipfel, R. M. Williams, W. W. Webb, “Nonlinear magic: multiphoton microscopy in the biosciences”, Nat. Biotechnol. 21(#11), pp. 1368-1376, 2003.
[8] F. Madzharova, Z. Heiner, J. Kneipp, “Surface enhanced hyper-Raman scattering of the amino acids tryptophan, histidine, phenylalanine, and tyrosine”, J. Phys. Chem. C 121(#2), pp. 1235-1242, 2017.
[9] L. D. Ziegler, “Hyper-Raman spectroscopy”, J. Raman Spectrosc. 21(#12), pp. 769-779, 1990.
[10] R. Shimada, H. Kano, H. O. Hamaguchi, “Hyper-Raman microspectroscopy: a new approach to completing vibrational spectral and imaging information under a microscope”, Opt. Lett. 31(#3), pp. 320-322, 2006.
[11] H. Kneipp, K. Kneipp, F. Seifert, “Surface-enhanced hyper-Raman scattering (SEHRS) and surface-enhanced Raman scattering (SERS) by means of mode-locked Ti-sapphire laser excitation”, Chem. Phys. Lett. 212 (#3-4), pp. 374-378, 1993.
[12] D. Cialla, T. Deckert-Gaudig, C. Budich, M. Laue, R. Moller, D. Naumann, V. Deckert, J. Popp, “Raman to the limit: tip-enhanced Raman spectroscopic investigations of a single tobacco mosaic virus”, J. Raman Spectrosc. 40(#3), pp. 240-243 (2009).
[13] J. D. Driskell, Y. Zhu, C. D. Kirkwood, Y. P. Zhao, R. A. Dluhy, R. A. Tripp, “Rapid and sensitive detection of rotavirus molecular signatures using surface enhanced Raman spectroscopy”, PLoS ONE 5(#4), e10222 (2010).
[14] P. Hermann, A. Hermelink, V. Lausch, G. Holland, L. Moller, N. Bannert, D. Naumann, “Evaluation of tip-enhanced Raman spectroscopy for characterizing different virus strains”, Analyst 136(#6), pp. 1148-1152 (2011).
[15] X. X. Han, B. Zhao, Y. Ozaki, “Label-free detection in biological applications of surface-enhanced Raman scattering”, TRAC-Trend. Anal. Chem. 38, pp. 67-78 (2012).
[16] H. Sato, M. Ishigaki, A. Taketani, B. B. Andriana, “Raman spectroscopy and its use for live cell and tissue analysis”, Biomed. Spectrosc. Imaging 7(#3-4), pp. 97-104 (2018).
[17] K. Moor, Y. Terada, A. Taketani, H. Matsuyoshi, K. Ohtani, H. Sato, “Early detection of virus infection in live human cells using Raman spectroscopy”, J. Biomed. Opt. 23(#9), 097001 (2018).
[18] X. Zhang, X. L. Zhang, C. L. Luo, Z. Q. Liu, Y. Y. Chen, S. L. Dong, C. Z. Jiang, S. K. Yang, F. B. Wang, X. H. Xiao, “Volume-enhanced Raman scattering detection of viruses”, Small 15(#11), 1805516 (2019).
[19] Y. T. Yeh, K. Gulino, Y. H. Zhanga, A. Sabestien, T. W. Chou, B. Zhou, Z. Lin, I. Albert, H. G. Lu, V. Swaminathan, E. Ghedin, M. Terrones, “A rapid and label-free platform for virus capture and identification from clinical samples”, Proc. Natl. Acad. Sci. USA 117(#2), pp. 895-901 (2020).
[20] K. Olschewski, E. Kaemmer, S. Stoeckel, T. Bocklitz, T. Deckert-Gaudig, R. Zell, D. Cialla-May, K. Weber, V. Deckert, J. Popp, “A manual and an automatic TERS based virus discrimination”, Nanoscale 7(#10), pp. 4545-4552 (2015).
[21] J. Y. Lim, J. S. Nam, S. E. Yang, H. Shin, Y. H. Jang, G. U. Bae, T. Kang, K. I. Lim, Y. Choi, “Identification of newly emerging influenza viruses by surface-enhanced Raman spectroscopy”, Anal. Chem. 87(#23), pp. 11652-11659 (2015).
[22] V. Hoang, R. A. Tripp, P. Rota, R. A. Dluhy, “Identification of individual genotypes of measles virus using surface enhanced Raman spectroscopy”, Analyst 135(#12), pp. 3103-3109 (2010).
[23] L. Hamm, A. Gee, A. S. D. Indrasekara, “Recent advancement in the surface-enhanced Raman spectroscopy-based biosensors for infectious disease diagnosis”, Appl. Sci.-Basel 9(#7), 1448 (2019).
[24] S. A. Camacho, R. G. Sobral-Filho, P. H. B. Aoki, C. J. L. Constantino, A. G. Brolo, “Zika immunoassay based on surface-enhanced Raman scattering nanoprobes”, ACS Sensors 3(#3), pp. 587-594 (2018).
[25] M. Reyes, M. Piotrowski, S. K. Ang, J. Q. Chan, S. A. He, J. J. H. Chu, J. C. Y. Kah, “Exploiting the anti-aggregation of gold nanostars for rapid detection of hand, foot, and mouth disease causing enterovirus 71 using surface-enhanced Raman spectroscopy”, Anal. Chem. 89(#10), pp. 5373-5381 (2017).
[26] A. M. Paul, Z. Fan, S. S. Sinha, Y. L. Shi, L. D. Le, F. W. Bai, P. C. Ray, “Bioconjugated gold nanoparticle based SERS probe for ultrasensitive identification of mosquito-borne viruses using Raman fingerprinting”, J. Phys. Chem. C 119(#41), pp. 23669-23675 (2015).
[27] M. M. Joseph, N. Narayanan, J. B. Nair, V. Karunakaran, A. N. Ramya, P. T. Sujai, G. Saranya, J. S. Arya, V. M. Vijayan, K. K. Maiti, “Exploring the margins of SERS in practical domain: An emerging diagnostic modality for modern biomedical applications”, Biomater. 181, pp. 140-181 (2018).
[28] X.-M. Lin, T. Deckert-Gaudig, P. Singh, M. Siegmann, S. Kupfer, Z. Zhang, S. Grafe and V. Deckert, arXiv:1604.06598 (2016).
[29] Z. He, Z. H. Han, M. Kizer, R. J. Linhardt, X. Wang, A. M. Sinyukov, J. Z. Wang, V. Deckert, A. V. Sokolov, J. Hu, M. O. Scully, “Tip-enhanced Raman imaging of single-stranded DNA with single base resolution”, J. Am. Chem. Soc. 141(#2), pp. 753-757 (2019).
[30] N. N. Ledentsov and V. A. Shchukin, “Novel concepts for injection lasers”, Opt. Eng. 41(#12), pp. 3193-3203, December 2002.
[31] M. V. Maximov, Y. M. Shernyakov, I. I. Novikov, L. Y. Karachinsky, N. Yu. Gordeev, U. Ben-Ami, D. Bortman-Arbiv, A. Sharon, V. A. Shchukin, N. N. Ledentsov, T. Kettler, K. Posilovic, D. Bimberg, “High-power low-beam divergence edge-emitting semiconductor lasers with 1- and 2-D photonic bandgap crystal waveguide”, IEEE J. Sel. Topics Quantum Electorn. 14(#4), pp. 1113-1122, July-August 2008.
[32] L. Liu, H. Qu, Y. Liu, Y. Zhang, Y. Wang, A. Qi, W. Zheng, “High-power narrow-vertical-divergence photonic band crystal laser diodes with optimized epitaxial structure”, Appl. Phys. Lett. 105(#23), Art. 231110, December 2014.
[33] M. J. Miah, T. Kettler, K. Posilovic, V. P. Kalosha, D. Skoczowsky, R. Rosales, D. Bimberg, J. Pohl, M. Weyers, “1.9 W continuous-wave single transverse mode emission from 1060 nm edge-emitting lasers with vertically extended lasing area”, Appl. Phys. Lett. 105(#15), Art. 151105, October 2014.
[34] X. L. Ma, A. J. Liu, H. W. Qu, Y. Liu, P. C. Zhao, X. J. Guo, W. H. Zheng, “Nearly diffraction-limited and low-divergence tapered lasers with photonic crystal structure”, IEEE Photon. Technol. Lett. 28(#21), pp. 2403-2406, November 2016.
[35] F.-H. Chu, G. A. Smolyakov, K. J. Malloy, A. A. Ukhanov, “Novel semiconductor-laser-integrated active AFM optical probe with ultrashort pulses and nanoscale aperture”, Proc. SPIE 11967, Single Molecule Spectroscopy and Superresolution Imaging XV, 1196707, 2022.

We claim:

1. A semiconductor-laser-integrated silicon or silicon nitride atomic force microscopy optical probe comprising:
a semiconductor laser chip providing a gain medium section; and
a silicon or silicon nitride cantilever atomic force microscopy probe, all integrated into a single chip, wherein said silicon or silicon nitride cantilever atomic force microscopy probe is an atomic force microscopy probe comprising a base, a cantilever, a tip formed at the end of the cantilever, and wherein the laser light emitted by said semiconductor laser chip is coupled into the probe tip as a result of propagation of the laser light in free space or in air.

2. The atomic force microscopy optical probe of claim 1, wherein the semiconductor laser chip is bonded to the surface of the base or buried in the base of the silicon or silicon nitride cantilever atomic force microscopy probe right in front of the cantilever or at some distance from the cantilever and aligned with the probe tip to couple the laser light into the probe tip.

3. The atomic force microscopy optical probe of claim 2, wherein the semiconductor laser chip is fabricated from a specially designed semiconductor laser epitaxial structure with significantly improved divergence across the epitaxial layers to radically improve coupling of the laser light into the probe tip.

4. The atomic force microscopy optical probe of claim 3, wherein the semiconductor laser chip is a three-section device divided into electrically isolated gain section and two absorber sections, located on both sides of the gain section, and the two absorber sections are used as photodetectors for detection of external light.

5. The atomic force microscopy optical probe of claim 3, wherein the semiconductor laser chip is a two-section device divided into electrically isolated gain section and saturable absorber section to allow ultrafast pulse generation.

6. The atomic force microscopy optical probe of claim 5, wherein the saturable absorber section of the semiconductor laser chip is used as a photodetector for intracavity light detection.

7. The atomic force microscopy optical probe of claim 3, wherein a second semiconductor laser chip with the same epitaxial structure is bonded to the surface of the base or buried in the base of the silicon or silicon nitride cantilever atomic force microscopy probe alongside the first semiconductor laser chip.

8. The atomic force microscopy optical probe of claim 7, wherein the second laser chip is used for detection of the light scattered from the probe tip.

9. The atomic force microscopy optical probe of claim 7, wherein the first and second semiconductor laser chips are vertically integrated stacks of two or more semiconductor laser chips designed for laser emission at different wavelengths.

10. The atomic force microscopy optical probe of claim 9, wherein the first and second semiconductor laser chips are used for laser generation and light detection at multiple wavelengths in the first and second semiconductor laser chips, respectively.

11. The atomic force microscopy optical probe of claim 1, wherein the semiconductor laser chip is based on one of the following semiconductor materials: GaAs, InP, GaP, GaSb, and GaN.

12. The atomic force microscopy optical probe of claim 1, wherein the optical gain in the semiconductor laser chip is provided by bulk active region.

13. The atomic force microscopy optical probe of claim 1, wherein the optical gain in the semiconductor laser chip is provided by a single quantum well active layer or by multiple quantum well active layers.

14. The atomic force microscopy optical probe of claim 1, wherein the optical gain in the semiconductor laser chip is provided by a single layer or by multiple layers of quantum dots in the active region of the epitaxial structure.

15. The atomic force microscopy optical probe of claim 1, wherein the epitaxial structure of the semiconductor laser chip is that of quantum cascade semiconductor laser.

16. A method for virus detection and identification, the method comprising:
providing a semiconductor-laser-integrated silicon or silicon nitride atomic force microscopy optical probe comprising a semiconductor laser chip providing a gain medium section, a silicon or silicon nitride cantilever atomic force microscopy probe, and a photodetector, all integrated into a single chip;
mounting the semiconductor-laser-integrated silicon or silicon nitride atomic force microscopy optical probe on an atomic force microscopy system;
applying a direct current bias to the semiconductor laser chip such that the laser light power delivered to the tip apex of the probe is sufficient to do tip-enhanced Raman scattering or near-field scanning optical microscopy measurements;
applying reverse voltage bias to the photodetector;
performing a tip-enhanced Raman scattering measurement or near-field scanning optical microscopy measurement on a single virus particle.

17. The method of claim 16, wherein the semiconductor laser chip is a two-section device divided into electrically isolated gain section and saturable absorber section to allow ultrafast pulse generation, and the saturable absorber section is used as a photodetector for intracavity light detection in the near-field scanning optical microscopy measurement.

18. A method for DNA/RNA sequencing, the method comprising:
providing a semiconductor-laser-integrated silicon or silicon nitride atomic force microscopy optical probe comprising a semiconductor laser chip providing a gain medium section, a silicon or silicon nitride cantilever atomic force microscopy probe, and a photodetector, all integrated into a single chip;
mounting the semiconductor-laser-integrated silicon or silicon nitride atomic force microscopy optical probe on an atomic force microscopy system;
applying a direct current bias to the semiconductor laser chip such that the laser light power delivered to the tip apex of the probe is sufficient to do tip-enhanced Raman scattering or near-field scanning optical microscopy measurements;
applying reverse voltage bias to the photodetector;
performing a tip-enhanced Raman scattering measurement or near-field scanning optical microscopy measurement on a single-stranded DNA, double-stranded DNA, or RNA molecules, stretched and attached to a fixed surface at both ends, by way of base-to-base readout necessary for DNA/RNA sequencing.

19. The method of claim 18, wherein the semiconductor laser chip is a two-section device divided into electrically isolated gain section and saturable absorber section to allow ultrafast pulse generation, and the saturable absorber section is used as a photodetector for intracavity light detection in the near-field scanning optical microscopy measurement.
